(19) United States
(12) Patent Application Publication
(10) Pub. No.: US 2014/0273556 A1
(43) Pub. Date: Sep. 18, 2014

(54) HIGH-DENSITY MULTIDIRECTIONAL MIDPLANE

(71) Applicant: Silicon Graphics International Corp., Fremont, CA (US)

(72) Inventor: Jay Everett Nelson, Superior, CO (US)

(21) Appl. No.: 13/931,784

(22) Filed: Jun. 28, 2013

Related U.S. Application Data
(60) Provisional application No. 61/786,433, filed on Mar. 15, 2013.

(51) Int. Cl. H01R 12/71

(52) U.S. Cl. CPC H01R 12/71
USPC 439/78

(57) ABSTRACT

A midplane may include a printed circuit board (PCB) with a top surface and a bottom surface. A first plurality of midplane connectors may be disposed on one or more edges of the top surface. The first midplane connectors may have one or more pins that are longitudinally oriented parallel to the top surface of the PCB. The midplane may further include a second plurality of midplane connectors disposed on the top surface. The second midplane connectors may have one or more pins that are longitudinally oriented perpendicular to the top surface of the PCB.

### CROSS-REFERENCE TO RELATED APPLICATIONS

The present application claims the priority benefit of U.S. provisional application No. 61/786,433, titled “HIGH DENSITY MULTIDIRECTIONAL MIDPLANE,” filed Mar. 15, 2013, the disclosure of which is incorporated herein by reference.

### BACKGROUND

1. Field of the Invention

The present invention relates to data storage systems. More specifically, the present invention relates to midplanes used within confined data storage enclosures.

2. Description of the Related Art

The data storage market demands increasingly space efficient, high-density data storage systems. Such data storage systems typically include various types of servers, such as rack servers or server blades, but may also include other types of computer systems. In an effort to increase data storage densities within confined server enclosures, server manufacturers and data storage service providers employ a special type of printed circuit board (PCB) called a midplane. Midplanes effectively serve as “linking” boards because they bridge several otherwise independent PCB-based components, such as network cards and hard disk drives.

Midplanes known in the art are typically oriented perpendicular to the floor of an enclosure and create a “midplane” between two spaces within the enclosure. Each space is usually populated with additional PCB-based components that connect to the midplane on the side of the midplane that faces that particular space. Accordingly, midplanes known in the art feature midplane connectors on both sides. A typical server enclosure may employ a midplane to connect and house system processing cards on one side of the midplane while connecting and housing network interface cards on the opposite side.

Although previously attempted midplane solutions allow an enclosure to house more components than traditional server designs that lack midplanes altogether, they nevertheless limit data storage capabilities and user accessibility. Namely, midplanes known in the art midplanes lack connectors that feature pins oriented parallel with the surface of the midplane. As a result, they may only receive other PCB-based components that are oriented perpendicular to the midplane. Because such midplanes can only link component across a single midplane axis, they waste valuable opportunities for lateral expansion. In doing so, previously attempted midplane designs negatively constrain enclosure design options and fail to take advantage of space that would otherwise allow for higher-density data storage capabilities within confined enclosures. Relatedly, because such midplanes fail to orient components along multiple midplane axes, they also fail to provide user access to the midplane from multiple directions. In age of ever-increasing data storage densities and ever-shrinking enclosure sizes, users demand the ability to access enclosures from multiple directions.

Accordingly, there is a need in the art for a midplane that provides higher-density data storage capacities, greater enclosure design flexibility, and enhanced accessibility to midplane components.

### SUMMARY

The midplane of the present invention provides for higher-density data storage capacities, greater enclosure design flexibility, and enhanced accessibility to midplane components. The midplane is high-density and multidirectional (i.e., capable of linking PCB-based component along multiple midplane axes). It may also be hot-pluggable. As a result, the midplane of the present invention may link a high quantity of components within a confined space, laterally interface with hot-swappable storage modules, and allow users to quickly and conveniently access its contents from multiple directions. These features are extremely advantageous in light of ever-increasing consumer demands for smaller server enclosures that simultaneously offer higher-density data storage capabilities and improved accessibility. Because the midplane also makes the use of self-powered, hot-swappable storage modules possible, it may also make data storage systems more reliable by minimizing single points of failure. In an embodiment, the midplane may include PCB with a top surface and a bottom surface. A first plurality of midplane connectors may be disposed on one or more edges of the top surface. The first midplane connectors may have one or more pins that are pins longitudinally oriented parallel to the top surface of the PCB. The midplane may also include a second plurality of midplane connectors disposed on the top surface that have one or more pins. The one or more pins of the second midplane connectors may be longitudinally oriented perpendicular to the top surface of the PCB.

### BRIEF DESCRIPTION OF DRAWINGS

FIG. 1 is a perspective view of an exemplary high-density multidirectional midplane in accordance with the present invention.

FIG. 2 is a perspective view of the exemplary high-density multidirectional midplane of FIG. 1 partially populated with PCB-based components.

FIG. 3 is perspective view of an exemplary storage module connected to the exemplary high-density multidirectional midplane of FIG. 1.

### DETAILED DESCRIPTION

A high-density multidirectional midplane is provided. The midplane of the present invention provides for higher-density data storage capacities, greater enclosure design flexibility, and enhanced accessibility to midplane components. The midplane is high-density and multidirectional (i.e., capable of linking PCB-based component along multiple midplane axes). It may also be hot-pluggable. As a result, the midplane of the present invention may link a high quantity of components within a confined space, laterally interface with hot-swappable storage modules, and allow users to quickly and conveniently access its contents from multiple directions. These features are extremely advantageous in light of increasing consumer demands for smaller server enclosures that simultaneously offer higher-density data storage capabilities and improved accessibility. Because the midplane also makes the use of self-powered, hot-swappable storage modules possible, it may also make data storage systems more reliable by minimizing single points of failure. Although data storage systems are discussed herein for illustrative purposes, the present technology may be useful in other computer systems as well.

FIG. 1 is a perspective view of an exemplary high-density multidirectional in accordance with the present invention. In an embodiment, a high-density multidirectional midplane 100 may include a printed circuit board (PCB) 110 with a top surface 120 and a bottom surface 130. A first plurality of midplane connectors 140 may be disposed on one or more edges 150 of top surface 120. First midplane connectors 140 may have one or more pins 160 that may be longitudinally oriented parallel to top surface 120. First midplane connectors 140 allow midplane 100 to make efficient use of any available lateral space within an enclosure by linking components such that their PCBs are oriented parallel to midplane 100. The laterally linked PCBs may then themselves receive additional perpendicularly oriented storage media or other components.

Midplane 100 may further include a second plurality of midplane connectors 170 disposed on top surface 120. Second midplane connectors 170 may have one or more pins 180 that may be longitudinally oriented perpendicular to top surface 120. With second midplane connectors 170, midplane 100 may link perpendicularly oriented PCB-based components in addition to the lateral linking options provided by first midplane connectors 140. By possessing the ability to link PCB-based components along multiple axes (i.e. both parallel to and perpendicular to top surface 120), the present invention allows for increased data storage densities. Moreover, it also allows PCB-components to extend towards multiple sides of an enclosure, thereby allowing for multiple user access points. These additional access points make it easier for a user to access the components linked by midplane 100 in the event that the user needs to repair, replace, maintain, monitor, or otherwise service one of the components.

As discussed further with respect to FIG. 2, in some embodiments, bottom surface 130 of PCB 110 may remain free of midplane connectors so that it may be coupled flush with the floor of an enclosure. Allowing midplane 100 to rest on the floor of an enclosure provides any laterally linked PCBs with perpendicular support. Such PCBs may then interface with numerous heavy storage media that they could otherwise never support if used in conjunction with midplanes known in the art.

FIG. 2 is a perspective view of the exemplary high-density multidirectional midplane of FIG. 1 partially populated with PCB-based components. The present invention is particularly advantageous for providing high-density storage notwithstanding limited enclosure space. For example, in an embodiment, midplane 200 may include eight or more first midplane connectors 210. In other embodiments, even more first midplane connectors 210 may be utilized. For example, in the more densely packed embodiment shown in FIG. 2, midplane 200 may include at least nine first midplane connectors 210.

One or more of first midplane connectors 210 may be hot-pluggable. When hot-pluggable, first midplane connectors 210 allow PCB-based components to be plugged into and removed from first midplane connectors 210 without having to power down the greater data storage system or the PCB-based component itself. When hot-pluggable, first midplane connectors 210 include circuitry that regulates the influx of current into a PCB-based component when connected. The circuitry prevents either first midplane connector 210 or the plugged PCB-based component from receiving a damaging amount of current.

Like first midplane connectors 210, one or more second midplane connector 220 may be hot-pluggable. In an embodiment, the quantity of second midplane connectors 220 may be at least five, while in another embodiment the quantity may be at least seven. The present invention provides for great flexibility in designing a high density server enclosure. For example, in an embodiment, the quantity of first midplane connectors 210 plus the quantity of second midplane connectors 220 may be at least thirteen. In another embodiment, the quantity of first midplane connectors 210 plus the quantity of second midplane connectors 220 may be at least seventeen. The optimal quantity of first and second midplane connectors 210 and 220 will depend on design considerations, such as performance requirements, server enclosure dimensions, and power availability.

The present invention also provides for significant variety in the types of cards it may receive. In an embodiment, first midplane connectors 210 and second midplane connectors 220 may collectively include at least six types of midplane connectors. Second midplane connectors 220 may include a quantity of bus standards, such as Peripheral Component Interconnect Express (PCIe), standard Peripheral Component Interconnect (PCI), Peripheral Component Interconnect Extended (PCI-X), or Accelerated Graphics Port (AGP) standards. As a result, second midplane connectors 170 may receive a wide variety of PCB-based components, including network cards, sound cards, modems, USB or serial devices, TV tuner cards, disk controllers such as Serial Attached SCSI (SAS) controllers, SAS expander cards, power modules, or service processor cards. The present invention is also particularly useful in servers utilizing SAS expander cards. SAS expander cards may allow a server to utilize additional hard disk drives than it could otherwise support using a standard SAS controller. SAS expander card 280 may include an external cable (not shown), or it the external cable may be integrated within midplane 200 as shown in FIG. 2.

Midplane 200 provides significant flexibility with respect to enclosure design by including midplane connectors that are disposed both parallel with and perpendicular to top surface 230 of PCB 240. For example, as shown in FIG. 2, first and second midplane connectors 210 and 220 may both be disposed on top surface 230 rather than being distributed across top surface 230 and bottom surface 250. Because midplane 200 need not house any connectors on bottom surface 250, it may be disposed flush with the floor of an enclosure. In various embodiments in which midplane 200 is disposed flush with the floor of an enclosure, the enclosure provides enhanced accessibility because its contents may be accessed through the top of the enclosure. Specifically, because second midplane connectors 220 may be oriented perpendicular to top surface 230, midplane 200 may receive PCB-based components 260 that may likewise be longitudinally oriented perpendicular to top surface 230. As a result, PCB-based components 260 may extend upwardly towards the top of the enclosure. PCB-based components 260 may also include handles 270 that further increase the convenience associated with providing access through the top of an enclosure.

Similarly, because first midplane connectors 210 are oriented parallel with top surface 230, they may allow midplane 200 to link PCB-based components laterally. For example, in an embodiment, one or more of first midplane connectors 210 may be storage module connectors (shown in FIG. 3), which may include or function similarly to SAS expander cards. Each such connector may connect to a storage module (not shown) that may be toollessly attachable and hot-swappable. Such storage modules may store storage media at high densities. In some embodiments, such hardware may be used in place of or in addition to utilizing the toolless attachment mechanisms described herein.

Each storage module may include up to fifteen storage media and may include its own on-board power supply. Because each storage is hot-swappable in such embodiments, a single failure within the PCB of any given storage module does not require that a user shut down either midplane 200 or the greater data storage system to service the storage module. Accordingly, the present invention increases system reliability by allowing servers to utilize hot-swappable, self-powered storage modules rather than utilizing a completely interconnected systems that constitutes a single point of failure.

As shown in FIG. 2, midplane 200 includes nine first midplane connectors 210, each of which may receive a storage module or other lateral PCB-based component. Because each storage module contains up to fifteen storage media, midplane 200 may link well over one-hundred data storage media. Such media can collectively weigh hundreds of pounds. Midplanes known in the art are oriented perpendicular to the enclosure floor. As a result, their connectors force media to remain suspended perpendicular to the floor and they cannot support as many storage media as a PCB oriented parallel to and supported by the floor of an enclosure. The downward gravitational pull on the heavy and perpendicularly suspended storage media applies undue stress upon the connectors, the midplane, and the storage media.

The midplane of the present invention, on the other hand, may receive storage modules or other PCB-based component laterally such that their PCBs rest parallel to midplane 200. As a result, the heavy storage media housed within the storage modules may be supported by the floor of the enclosure. At the same time, the storage media may also be oriented perpendicular to midplane 200 such that they may be accessed through the top of the enclosure along with the PCB-based components disposed on midplane 200. Among the other benefits described above, the ability of the present invention to link PCB-based components along multiple midplane axes ultimately provides for improved storage capacity and accessibility within confined enclosures.

FIG. 3 is a perspective view of an exemplary storage module connected to the exemplary high-density multidirectional midplane of FIG. 1. A toolless hot-swappable storage module system 300 includes a base plate 305 for mounting within a computer enclosure 310 and a toolless hot-swappable storage module 315. Storage module 315 may house a plurality of storage media 320. In an embodiment shown in FIG. 3, storage module 315 houses up to nine storage media 320 at once. In other embodiments, other quantities of storage media 320 may be housed depending on customer needs and design considerations related to the greater data storage system. Storage module 315 includes a sled 325 that is removably coupled to base plate 305. Base plate 305 and sled 325 may include a variety of corresponding toolless attachment mechanisms. The toolless attachment mechanism allows storage module 315 to be quickly inserted into and removed from enclosure 310 without the use of tools or fastening hardware.

In an embodiment, base plate 305 may include a first set of rails 330 and sled 325 may include a second set of rails 335 that correspond to first set of rails 330. In another embodiment, base plate 305 may include one or more channels and sled 325 may include one or more rollers that correspond to the channels. Similarly, base plate 305 may include one or more channels and sled 325 may include one or more ball bearings that correspond to the channels. Base plate 305 may also include one or more guide pins and sled 325 may include one or more notches that correspond to the guide pins. Base plate 305 may include a first flange and sled 325 may include a second flange that corresponds to and interlocks with the first flange. Either base plate 305 or sled 325 may include a lubricious material that allows one to slide upon the other. The present invention may utilize any toolless attachment mechanism that allows storage module 315 to quickly slide into and be removed from enclosure 310.

Storage module 315 further includes a PCB 340 that is disposed on sled 325. Sled 325 may be attached to PCB 340 through a swaging process or similar commonly known attachment methods. PCB 340 includes a plurality of storage media connectors 345, a PCB plug-in connector 350, and a power supply (not shown). PCB 340 communicates with storage media 320 and may also include various other signal and power connections, sensors, switches, might-emitting diodes (LEDs), or logic. Storage media connectors 345 may utilize a variety of interfaces, including Shugart Associates System Interface (SASI), Small Computer System Interface (SCSI), Serial Attached SCSI (SAS), Seagate Technology 506 (ST-506), Seagate Technology 412 (ST-412), Enhanced Small Disk Interface (SDI), Parallel AT Attachment (PATA), or Serial ATA (SATA).

PCB plug-in connector 350 allows storage module 315 to be quickly plugged into first midplane connector 210 of FIG. 2. The power supply provides power to the electronics of PCB 340 and to storage media 320. Because PCB 350 is self-powered as opposed to being powered only when plugged into first midplane connector 210 of FIG. 2, storage module 315 may remain powered even when disconnected from the same. This feature makes storage module 315 hot-swappable and allows for enhanced reliability when providing data storage services to customers because the greater data storage system need not be taken offline when a single PCB needs to be serviced.

Storage module 315 also includes a support frame 360 that is disposed on PCB 340. Support frame 360 supports storage media 320. Support frame 360 includes a plurality of support members 365 that are disposed perpendicular to PCB 340. In an embodiment, support frame 360 supports storage media 320 by holding them in a vertical position. By maintaining storage media 320 is a vertical position, support frame 360 allows users to access storage media 320 through the top of enclosure 310. As a result, users may access multiple layers of storage media 320 at once as opposed to traditional storage modules that limit a user to accessing a single layer of storage media 320 at a time through the front of an enclosure. Each support member 365 has a first edge 370 and a second edge 375 and includes a plurality of dividers 380 that are disposed in parallel rows. Dividers 380 isolate each individual storage medium 320 and help to prevent them from moving around within storage frame 360.

PCB 340 may be disposed horizontally and support members 365 and rows of dividers 380 may be disposed vertically. Alternatively, PCB 340 may be disposed vertically and support members 365 and rows of dividers may be disposed horizontally. Support frame 360 also includes a sidewall 385 that is disposed across first edge 370 of support members 365. Sidewall 385 provides support frame 360 with enhanced structural rigidity in addition helping to shield storage media 320 from particular matter within enclosure 310. Support frame 360 may further include a plurality of retention members 390 that are disposed across first edges 370 of support members 365. Retention members 390 may include locking handles, rotating latches, rotating covers, rotating screens, or flanges with passive detents. Retention members 390 further maintain the position of storage media 320 when storage module 315 is transported, such as during a hot swap removal. Retention members 390 may also be moved out of the way to facilitate enhanced access to storage media 320 when necessary, such as when removing storage media 320 for service or replacement.

As mentioned above, storage module 315 may be removed without having to shut down either storage media 320 or the greater data storage system. Prior to removal, a user may place storage media 320 into “service mode” by using a separate graphical user interface (GUI) to communicate with PCB 340. While in service mode, storage media 320 may continue to run without actively communicating with PCB 340. As a result, storage module 315 facilitates maintaining reliable data storage services notwithstanding any potential need to remove storage module 315 from enclosure 310.

By being able to link PCB-based components like storage module 300 along multiple midplane axes, the present invention ultimately provides for improved data storage capacity, greater user accessibility, and enhanced reliability in server systems utilizing confined enclosures.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A midplane, comprising:
a printed circuit board (PCB) with a top surface and a bottom surface;
a first plurality of midplane connectors disposed on one or more edges of the top surface of the PCB, the first midplane connectors having one or more pins, the one or more pins longitudinally oriented parallel to the top surface of the PCB;
a second plurality of midplane connectors disposed on the top surface of the PCB, the second midplane connectors having one or more pins, the one or more pins longitudinally oriented perpendicular to the top surface of the PCB.

2. The midplane of claim 1, wherein the bottom surface of the PCB is free of midplane connectors.

3. The midplane of claim 1, wherein one or more of the first midplane connectors is hot-pluggable.

4. The midplane of claim 1, wherein one or more of the second midplane connectors is hot-pluggable.

5. The midplane of claim 1, wherein one or more of the first midplane connectors are storage module connectors.

6. The midplane of claim 1, wherein the quantity of first midplane connectors is at least eight.

7. The midplane of claim 1, wherein the quantity of first midplane connectors is at least nine.

8. The midplane of claim 1, wherein the quantity of second midplane connectors is at least five.

9. The midplane of claim 1, wherein the quantity of second midplane connectors is at least eight.

10. The midplane of claim 1, wherein the quantity of first midplane connectors plus the quantity of second midplane connectors is at least thirteen.

11. The midplane of claim 1, wherein the quantity of first midplane connectors plus the quantity of second midplane connectors is at least seventeen

12. The midplane of claim 1, wherein the first midplane connectors and the second midplane connectors collectively include at least six types of midplane connectors.
